(19) United States
(12) Patent Application Publication
(10) Pub. No.: US 2026/0014620 A1
(43) Pub. Date: Jan. 15, 2026

(54) Method for Obtaining Base Metal and Alloy through High-Temperature Sintering and Anti-Oxidizing in Air

(71) Applicant: CHANGSHA ZONEKEY PATENT LAW FIRM, Hunan (CN)

(72) Inventor: Wen-Hsi Lee, Tainan (TW)

(21) Appl. No.: 18/997,879

(22) PCT Filed: Aug. 11, 2022
(86) PCT No.: PCT/CN2022/111633

§ 371 Date: Jan. 23, 2025

(51) Int. Cl. B22F 3/10; B22F 7/04; B32B 15/04; B32B 15/20; H01C 1/14

(52) U.S. Cl. CPC B22F 3/10; B22F 7/04; B32B 15/04; B32B 15/20; B22F 2007/047; B22F 2301/052; B22F 2301/10; B22F 2301/15; B22F 2998/10; B22F 2999/00; B32B 2250/02; B32B 2311/12; B32B 2311/22; B32B 2311/24; H01C 1/14

(57) ABSTRACT

A method is provided for sintering base metal or alloy at high temperature in the air. They are used for thick-film printing, where precious metals are completely changed to base metals. Moreover, unlike the current practice where a reduction atmosphere is required to avoid metal oxidization, the present invention is the first to allow very cheap base metals to be sintered at high temperature in the very cheap air while maintaining their excellent electrical features. Therefore, there is no need to change equipment for related industries. The original equipment can still be used for sintering in the air. In other words, it is possible to use base metals instead of precious metals for significantly reducing the material cost. It will lead the world in revolutionary technologies related to using base metals in thick-film printing.

### TECHNICAL FIELD OF THE INVENTION

The present invention relates to sintering and anti-oxidizing base metal at high temperature in the air; more particularly, to sintering a base-metal or alloy conductor at high temperature in the air for thick-film printing, where the base metal or alloy avoids oxidation on being sintered in the air while maintaining excellent electrical features.

### DESCRIPTION OF THE RELATED ARTS

Current technical problems of thick-film printing with conductive paste are as follows:
1. Thick-film printing with precious metal like silver (Ag) or Ag-palladium (Pd) alloy can be processed through heat treatment of sintering at high temperature in the air. However, the precious metals or alloys that can be sintered at high temperature in the air without being easily oxidized are expensive.
2. If the precious metal like Ag or Ag—Pd alloy is replaced by base metal like copper (Cu), nickel (Ni), or Cu—Ni alloy for thick-film printing, the heat treatment of sintering must be processed at high temperature under a reducing atmosphere (with nitrogen or mixed nitrogen-hydrogen) for avoiding the loss of features owing to oxidizing the base metal. Although changing the material from precious metal to base metal can reduce cost, the heat treatment must be changed from sintering in the air to sintering in a restoring atmosphere, where, in turn, the cost of sintering is significantly increased.
3. Some base metal materials are not amenable to high-temperature heat treatment even in a restoring atmosphere. For example, when an alloy resistance material, like Cu-manganese (Mn) alloy or Ni-chromium (Cr) alloy, is used for chip resistor, or when an electrode is used in ceramic thermistor or magnetic inductor, the original ceramic part is sintered under a restoring atmosphere with feature changed and, as a result, the heat treatment of sintering for fabricating the part can only be processed in the air.

The shortcomings and disadvantages of current technologies are collected as follows:
1. Existing technologies of heat treatment of sintering for base-metal thick-film-printed conductive Cu, Ni, Cu—Ni alloy paste films must be processed under a reducing atmosphere such as a nitrogen or mixed hydrogen-nitrogen gas to prevent the base metal of Cu, Ni, or other alloy from being oxidized and further losing functions. However, although the prices of base metals and alloys are cheap, the restoring atmosphere for the heat treatment of sintering significantly increases the cost.
2. Current method of co-firing ceramic green body and electrode with a multilayer ceramic part will cause the problem of shrinkage mismatch. Existing technical solutions include covering a non-shrinkable ceramic green body, which has a higher temperature of sintering than a co-fired ceramic green body, or inserting another ceramic green body which has a lower temperature of sintering than the co-fired ceramic green body to inhibit shrinkage on X and Y axes on co-firing for reducing the mismatch of the ceramic green body to the electrode. However, this extra step adds cost.
3. For some modern way of fabricating external electrode with ceramic part, the sintered ceramic part changes its features after the external electrode is sintered in a restoring atmosphere. The external electrode, for example, can be a chip resistor, a thermistor with negative temperature coefficient (NTC), a thermistor with positive temperature coefficient (PTC), a voltage dependent resistor (VDR), or a piezoelectric Pb(ZrTi)O₃ (PZT) device. Therein, a nitrogen-sintered Cu electrode is not applicable.
4. Existing chip alloy resistors have very low resistance-temperature coefficients, which are made mainly by printing both ends of a positive electrode paste on a substrate 61; then, an alloy resistance-paste is printed; and, then, precious-metal Ag electrodes 62,63 and an Ag—Pd alloy resistor layer 64 are sintered in the air for fabrication, whose flow is shown in FIG. 18. Or, a base-metal Cu electrode or Cu—Ni alloy resistor layer is sintered in a restoring nitrogen atmosphere for fabrication. However, the price of precious metal Ag—Pd is expensive; and, although the price of base metal Cu—Ni alloy is cheap, the restoring atmosphere for the heat treatment of sintering is required to avoid oxidation and thus leads to a significant increase in cost.

Owing to global increase in the raw-material prices of precious metals, there is an urgent need of replacement with the world's rich collection of raw materials of base metals. However, current conductive paste films of base metal or alloy for thick film printing through sintering in a restoring atmosphere do not meet technical and market demands. Hence, the prior arts do not fulfill all users' requests on actual use.

### SUMMARY OF THE INVENTION

The main purpose of the present invention is to completely change the materials for the thick-film printing from precious metals to base metals, where the metal or alloy materials used are very cheap for being sintered at high temperature in the cheap process air without being oxidized while maintaining excellent electrical features; and the material cost is significantly reduced with no additional equipment required.

To achieve the above purpose, the present invention is a method for obtaining base metal and alloy through high-temperature sintering and anti-oxidizing in the air, where 10˜90 weight percent (wt %) of a metallic Al powder is added to a thick-film printed base-metal conductive paste or thick-film printed base-metal alloy paste to process a heat treatment at 500˜1400° C. in the air with the high oxophilicity of said metallic Al powder protecting the thick-film printed base-metal conductive paste or thick-film printed base-metal alloy paste from oxidation on being sintered at the high temperature in the air; at a chance of causing the thick-film printed base-metal conductive paste or thick-film printed base-metal alloy paste oxidized on being sintered at high temperature in the air, the oxidized thick-film printed base-metal conductive paste or thick-film printed base-metal alloy paste is reduced back to a metal or alloy through the strong reduction of the metallic Al powder; and a thick-film base-metal electrode film or thick-film base-metal alloy film is thus obtained.

Another method for obtaining the base metal and alloy according to the present invention is to obtain a layer of a thick-film Al conductive paste film to be printed on a thick-film printed base-metal conductive paste film or thick-film printed base-metal alloy paste film to process a heat treatment at 500˜1400° C. in the air with the high oxophilicity of the conductive Al paste thick-film protecting the thick-film printed base-metal conductive paste film or thick-film printed base-metal alloy paste film from oxidation on being sintered at high temperature in the air; at a chance of causing the thick-film printed base-metal conductive paste film or thick-film printed base-metal alloy paste film oxidized on being sintered at high temperature in the air, the oxidized thick-film printed base-metal conductive paste film or thick-film printed base-metal alloy paste film is reduced back to a metal or alloy through the strong reduction of the conductive Al paste thick-film; and a thick-film base-metal electrode film or thick-film base-metal alloy film is thus obtained. Accordingly, a novel method for obtaining base metal and alloy through high-temperature sintering and anti-oxidizing in the air is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the thermal analysis of weight increase of the aluminum (Al)-added copper (Cu) following the increase of temperature;

FIG. 2 is the view showing the thermal analysis of weight increase of the Al-added nickel (Ni) following the increase of temperature;

FIG. 3A˜3E is the view showing the microstructure of the sintered Al-added Cu;

FIG. 4A˜4H is the view showing the microstructure of the sintered Al-added Ni;

FIG. 5A˜5B is the view showing the microstructure of the sintered Ni—Al alloy;

FIG. 6A˜6C is the view showing the microstructure of the sintered Cu film coated with the Al film;

FIG. 7A˜7C is the view showing the microstructure of the sintered Ni film coated with the Al film;

FIG. 8A˜8D is the view showing the microstructure of the sintered Cu—Ni film coated with the Al film;

FIG. 9A˜9D is the view showing the microstructure of the sintered Cu-manganese (Mn) film coated with the Al film;

FIG. 10A˜10B is the structural view showing the external electrode of the block-shaped ceramic part;

FIG. 11A˜11B is the structural view showing the non-shrunk inner electrode of the multilayer ceramic part;

FIG. 12A˜12D is the structural view showing the non-shrunk multilayer inner electrode of the multilayer ceramic part;

FIG. 13A˜13D is the structural view showing the chip resistor electrode;

FIG. 14 is the view showing the microstructure of the chip resistor electrode;

FIG. 15A˜15D is the structural view showing the chip alloy resistor;

FIG. 16 is the structural view showing the base-metal alloy chip resistor;

FIG. 17A˜17B is the view showing the microstructure of the chip alloy resistor; and

FIG. 18 is the view of the prior art.

### DESCRIPTION OF THE PREFERRED EMBODIMENT

The following description of the preferred embodiment is provided to understand the features and the structures of the present invention.

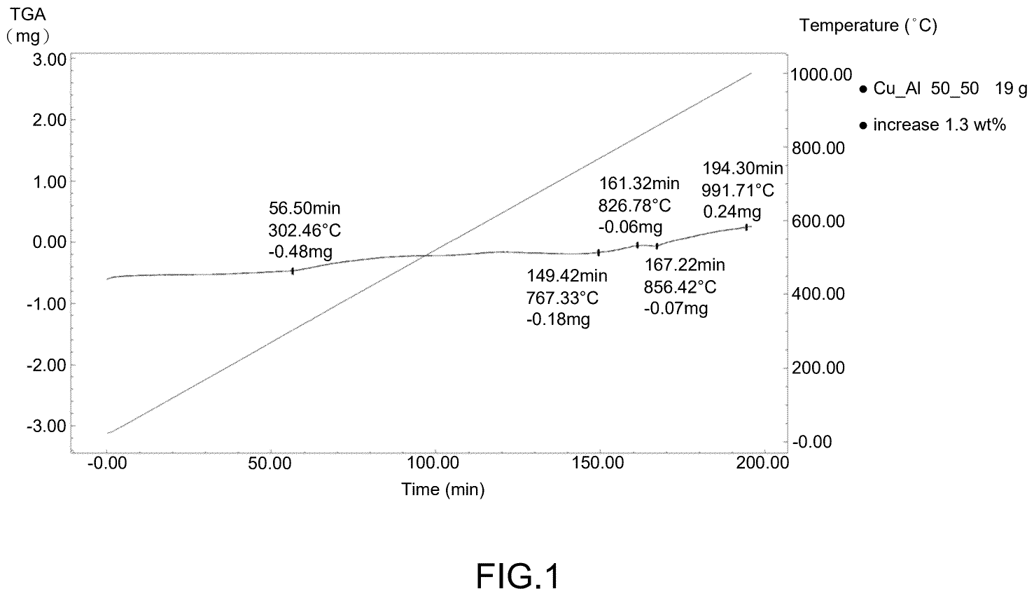

Please refer to FIG. 1 to FIG. 17A˜17B, which are a view showing a thermal analysis of weight increase of an Al-added Cu following the increase of temperature; a view showing a thermal analysis of weight increase of an Al-added Ni following the increase of temperature; a view showing a microstructure of a sintered Al-added Cu; a view showing a microstructure of a sintered Al-added Ni; a view showing a microstructure of a sintered Ni—Al alloy; a view showing a microstructure of a sintered Cu film coated with an Al film; a view showing a microstructure of a sintered Ni film coated with an Al film; a view showing a microstructure of a sintered Cu—Ni film coated with an Al film; a view showing a microstructure of a sintered Cu—Mn film coated with an Al film; a structural view showing an external electrode of a block-shaped ceramic part; a structural view showing a non-shrunk inner electrode of a multilayer ceramic part; a structural view showing a non-shrunk multilayer inner electrode of a multilayer ceramic part; a structural view showing a chip resistor electrode; a view showing a microstructure of a chip resistor electrode; a view showing a microstructure of a chip alloy resistor; a structural view showing a base-metal alloy chip resistor; and a view showing a microstructure of the chip alloy resistor. As shown in the figures, the present invention is a method for obtaining base metal and alloy through high-temperature sintering and anti-oxidizing in the air, where 10˜90 weight percent (wt %) of a metallic Al powder is added to a thick-film printed conductive base-metal paste or a thick-film printed base-metal alloy paste (or a layer of a thick-film Al conductive paste film is printed on a thick-film printed base-metal conductive paste film or a thick-film printed base-metal alloy paste film) to process a heat treatment at 500˜1400 degrees Celsius (° C.) in the air. The high oxophilicity and strong reduction of Al are used. The high oxophilicity of a metallic Al powder protects the base-metal conductor or base-metal alloy from oxidation on being sintered at high temperature in the air. At a chance of causing the base-metal conductor or base-metal alloy oxidized on being sintered at high temperature in the air, the strong reduction of the metallic Al powder is used to reduce the oxidized base-metal conductor or base-metal alloy back to metal and alloy for obtaining a thick-film base-metal electrode film or alloy film. A base-metal conductor (such as Cu or Ni) or a base-metal alloy (such as Cu—Ni alloy) is originally easily oxidized on being sintered at high temperatures in the air, but the conductivity of the metal or the features of the alloy can be still remained now.

The following descriptions of the state-of-uses are provided to understand the features and the structures of the present invention.

Table 1, Table 2, and Table 3 show that, by adding a metallic Al powder to a metallic Cu powder or a metallic Ni powder (or, with a metallic Ni powder or a Cu—Ni alloy powder, fabricating a thick-film paste), a thick film is made through mesh printing. The resistance feature is then obtained through being sintered at 500˜900° C. in the air as a heat treatment.

TABLE 1

| Cu/Al | (10/90) | (20/80) | (30/70) | (40/60) | (50/50) |
|---|---|---|---|---|---|
| 500° C. | 0.969 | 0.912 | 0.777 | 0.623 | 0.532 |
| 600° C. | 0.223 | 0.339 | 0.221 | 0.121 | 0.137 |
| 700° C. | 0.075 | 0.112 | 0.144 | 0.111 | 0.126 |
| 800° C. | 0.072 | 0.172 | 0.192 | 0.135 | 0.108 |
| 900° C. | 0.086 | 0.167 | 0.187 | 0.259 | 0.387 |

| Cu/Al | (60/40) | (70/30) | (80/20) | (90/10) |
|---|---|---|---|---|
| 500° C. | 0.92 | 2.65 | — | — |
| 600° C. | 0.432 | 1.6 | — | — |
| 700° C. | 0.378 | 1.92 | — | — |
| 800° C. | 0.255 | 1.82 | — | — |
| 900° C. | 4.5 | — | — | — |

As shown in Table 1, a metallic Cu powder increases as following the increase of a metallic Al powder with strong anti-oxidation in the heat treatment, where 40 wt % of the metallic Al powder is added to 60 wt % of the metallic Cu powder to maintain the high conductivity of a Cu—Al mixed conductive paste sintered at 900° C. in the air.

TABLE 2

| Ni/Al | (10/90) | (20/80) | (30/70) | (40/60) | (50/50) |
|---|---|---|---|---|---|
| 500° C. | 1.11 | 0.832 | 0.972 | 1 | 0.917 |
| 600° C. | 0.099 | 0.112 | 0.131 | 0.147 | 0.181 |
| 700° C. | 0.085 | 0.15 | 0.312 | 0.375 | 0.675 |
| 800° C. | 0.072 | 0.12 | 0.219 | 3.06 | 12 |
| 900° C. | 0.092 | 0.21 | 0.345 | 5.7 | 23 |

| Ni/Al | (60/40) | (70/30) | (80/20) | (90/10) |
|---|---|---|---|---|
| 500° C. | 2.17 | 3.67 | — | — |
| 600° C. | 0.28 | 0.321 | — | — |
| 700° C. | 2.35 | — | — | — |
| 800° C. | — | — | — | — |
| 900° C. | — | — | — | — |

As shown in Table 2, a metallic Ni powder increases as following the increase of a metallic Al powder with strong anti-oxidation in the heat treatment, where 50 wt % of the metallic Al powder is added to 50 wt % of the metallic Ni powder to maintain the high conductivity of a Ni—Al mixed conductive paste sintered at 900° C. in the air.

TABLE 3

| CuNi + Al | (10/90) | (20/80) | (30/70) |
|---|---|---|---|
| 500° C. | 0.09/3000 ppm | 0.14/2900 ppm | 0.21/2850 ppm |
| 600° C. | 0.12/2900 ppm | 0.18/2800 ppm | 0.23/2800 ppm |
| 700° C. | 0.13/2850 ppm | 0.19/2780 ppm | 0.25/2770 ppm |
| 800° C. | 0.15/2800 ppm | 0.20/2710 ppm | 0.27/2750 ppm |
| 900° C. | 0.17/2750 ppm | 0.22/2650 ppm | 0.29/2700 ppm |

| CuNi + Al | (40/60) | | (50/50) | | (60/40) | |
|---|---|---|---|---|---|---|
| 500° C. | 0.27/1020 | ppm | 0.31/120 | ppm | 0.35/100 | ppm |
| 600° C. | 0.21/720 | ppm | 0.37/100 | ppm | 0.27/90 | ppm |
| 700° C. | 0.27/620 | ppm | 0.42/82 | ppm | 0.31/60 | ppm |
| 800° C. | 0.32/550 | ppm | 0.47/60 | ppm | 0.35/35 | ppm |
| 900° C. | 0.36/450 | ppm | 0.49/25 | ppm | 0.37/28 | ppm |

| CuNi + Al | (70/30) | | (80/20) | (90/10) |
|---|---|---|---|---|
| 500° C. | 0.41/90 | ppm | — | — |
| 600° C. | 0.45/81 | ppm | — | — |
| 700° C. | 0.48/52 | ppm | — | — |
| 800° C. | 0.52/29 | ppm | — | — |
| 900° C. | 0.55/7 | ppm | — | — |

As shown in Table 3, an alloy Cu—Ni powder increases as following the increase of a metallic Al powder with strong anti-oxidation in the heat treatment, where 40 wt % of the metallic Al powder is added to 60 wt % of the alloy Cu—Ni powder or 30 wt % of the metallic Al powder is added to 70 wt % of the alloy Cu—Ni powder; and, with both the above ratios of the alloy Cu—Ni powder added to the metallic Al powder, the good resistance of a Cu—Ni alloy Al-mixed resistor paste sintered at 900° C. in the air is remained as including a very low temperature-coefficient of resistance (TCR), i.e. TCR<±100 parts per million (ppm).

TABLE 4

| Al-film coated | | |
|---|---|---|
| Cu | Ni | CuNi(Cu/Ni = 55/45) |

| Sintering temp. | R | R | R | TCR |
|---|---|---|---|---|
| 800° C. | 9.2 mΩ | 67 mΩ | 108 mΩ | −98 ppm |
| 850° C. | 8.7 mΩ | 49 mΩ | 139 mΩ | −32 ppm |
| 900° C. | 8.1 mΩ | 55 mΩ | 176 mΩ | +78 ppm |

| | Al-film coated | | | |
|---|---|---|---|---|
| | CuMn(Cu/Mn = 88/12) | | NiCr(Ni/Cr = 60/40) | |
| Sintering temp. | R | TCR | R | TCR |
| 800° C. | 32 mΩ | −44 ppm | 2.3 Ω | +21 ppm |
| 850° C. | 41 mΩ | +52 ppm | 3.1 Ω | +66 ppm |
| 900° C. | 56 mΩ | +89 ppm | 5.9 Ω | +91 ppm |

As shown in Table 4, through thick-film printing, a metallic Al film is coated on a thick-film printed metallic Cu film, metallic Ni film, or alloy Cu—Ni, Cu—Mn, or Ni-chromium (Cr) film. With the electrical feature obtained through a heat treatment of sintering at 700˜900° C. in the air, the metallic Cu film or metallic Ni film covered with the metallic Al film remains an extremely low resistance value and the alloy Cu—Ni film covered with the metallic Al film remains an extremely low resistance value, where the feature includes an extremely low TCR (<+100 ppm) and a resistance equivalent to that of a conventional thick-film printed metallic Cu film, metallic Ni film, or alloy Cu—Ni film sintered under a reduction atmosphere (a nitrogen gas or a nitrogen-hydrogen mixed gas) or equivalent to the resistance feature including a low TCR.

In the temperature-varying thermogravimetric analysis (TGA) of the mixed paste with 50 wt % Cu and 50 wt % Al as shown in FIG. 1, it is found that there is little change in weight below 1000° C. That is, under the protection of the highly oxophilic Al powder, Cu is sintered in the air.

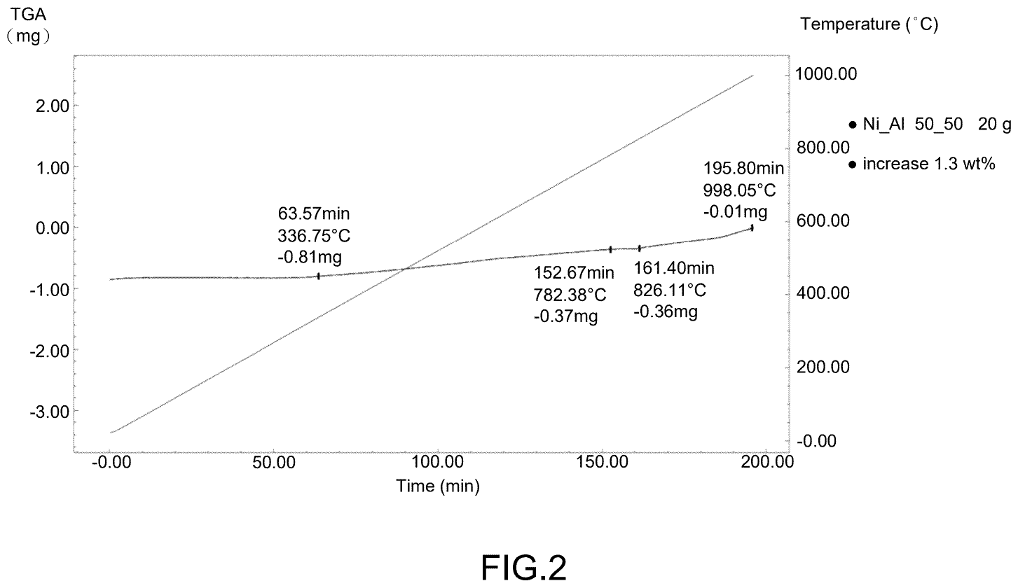

In the temperature-varying TGA of the mixed paste with 50 wt % Ni and 50 wt % Al as shown in FIG. 2, it is found that there is little change in weight below 1000° C. That is, under the protection of the highly oxophilic Al powder, Ni is sintered in the air.

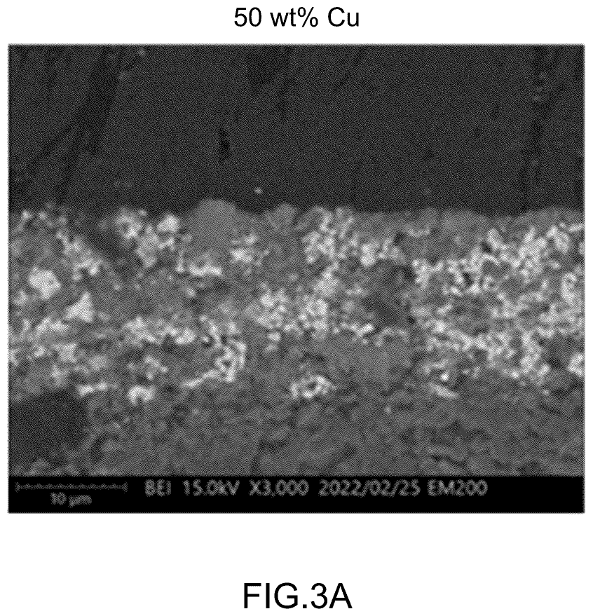

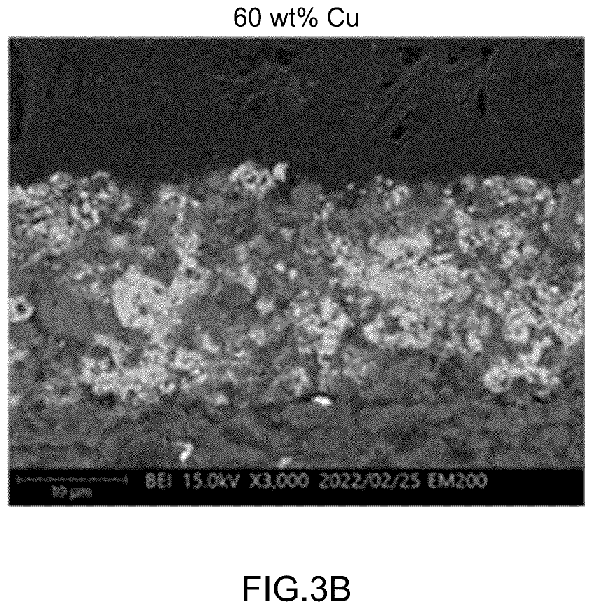

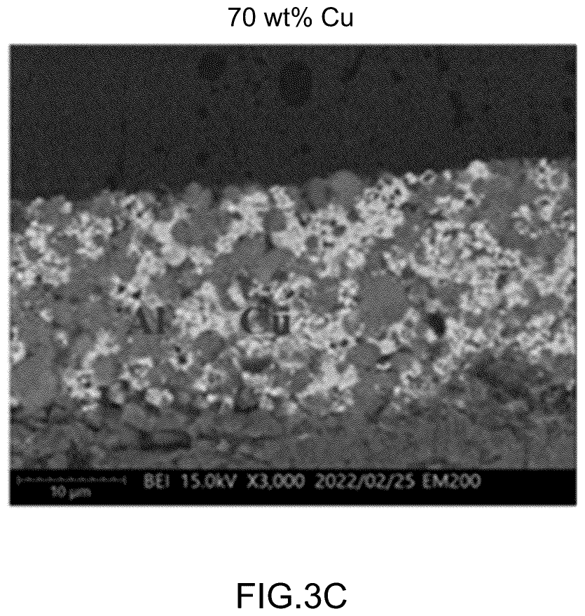

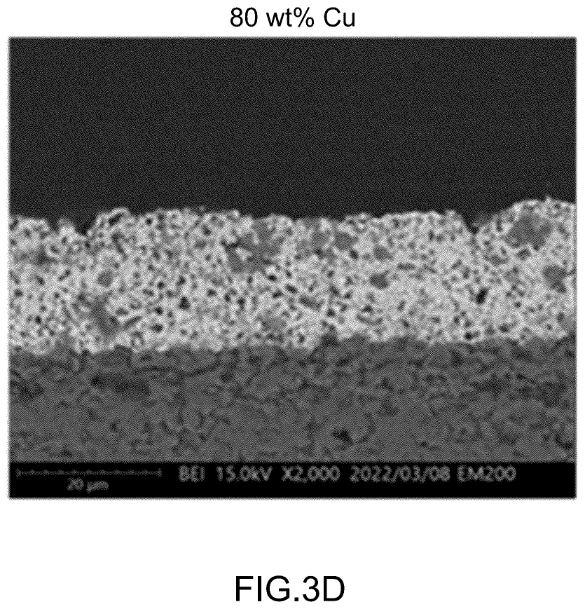

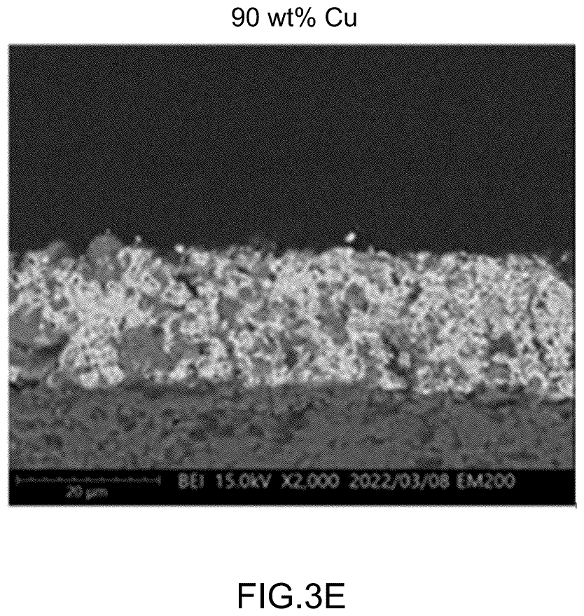

FIG. 3A˜3E shows a metallic Al powder added to a metallic Cu powder with the microstructure obtained under a sintering temperature of 850° C. per minute (° C./min) in the air. Due to the presence of the highly oxophilic Al powder, it is clearly observed that, even being sintered under high temperature in the air, Cu still remains its high conductivity.

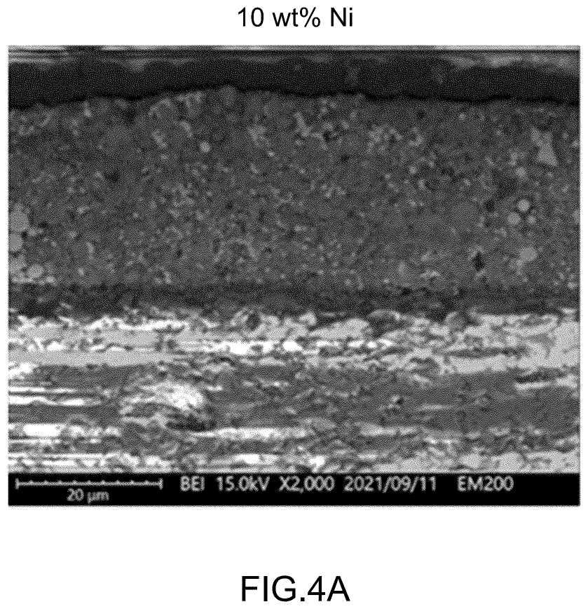

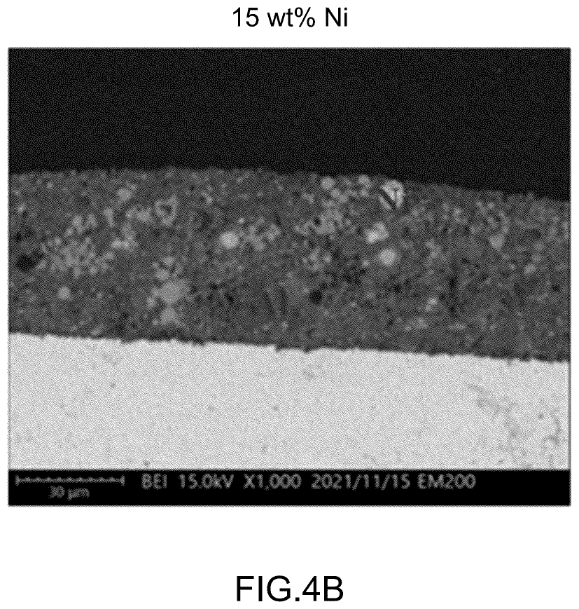

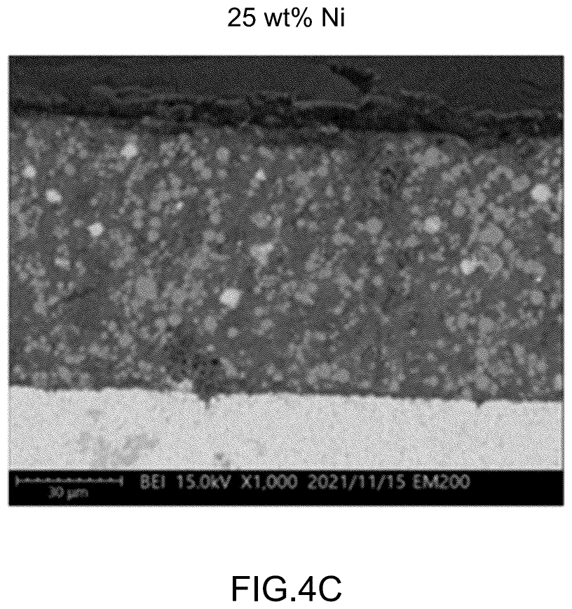

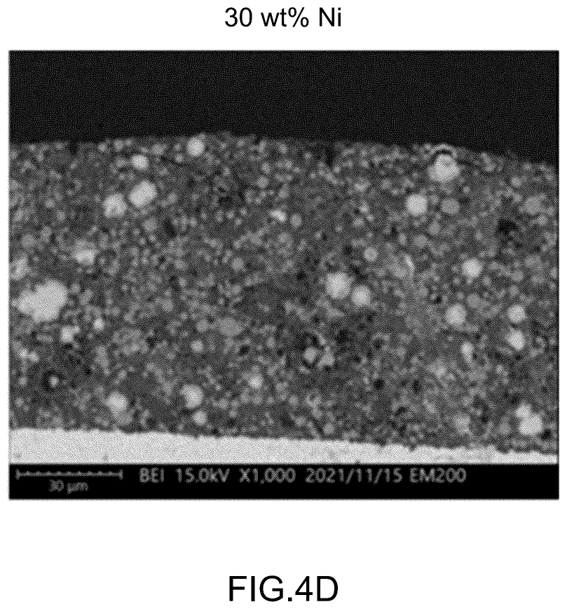

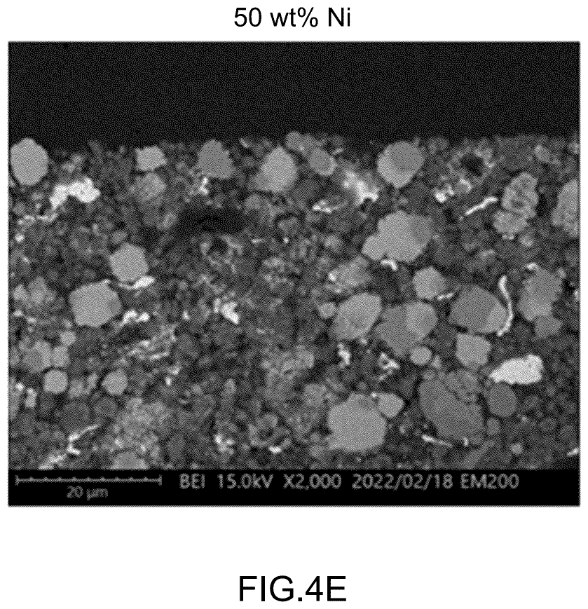

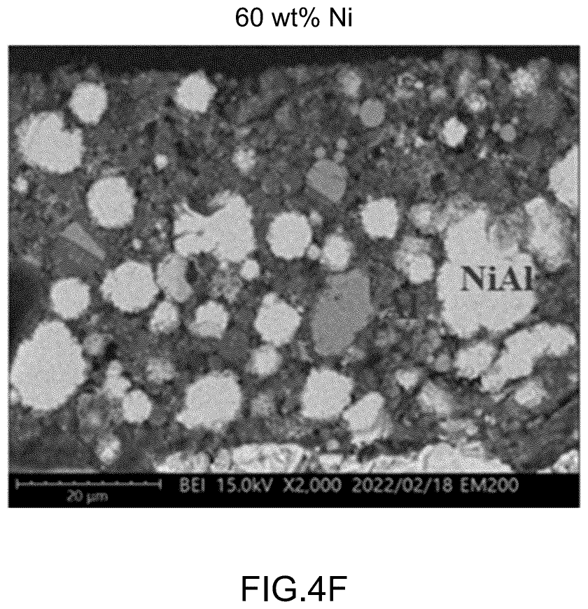

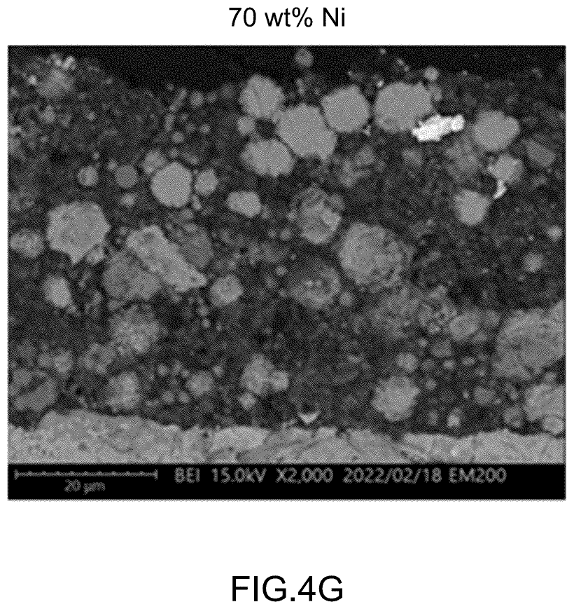

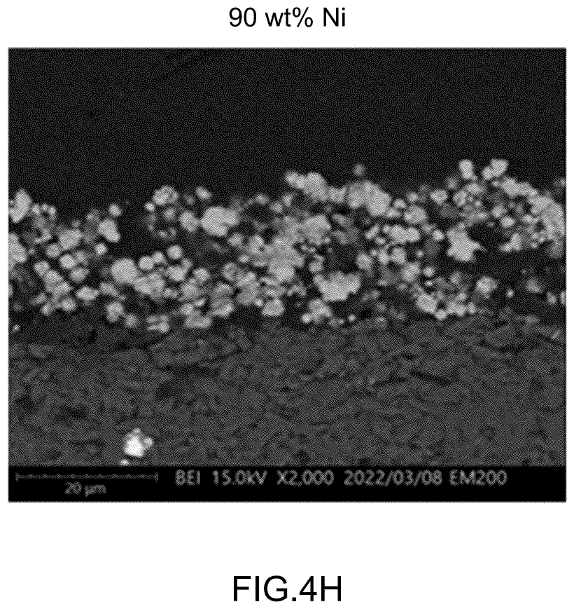

FIG. 4A˜4H shows the microstructures of different ratios of a metallic Cu powder added with a metallic Al powder to be sintered at a temperature of 850° C./min in the air. Due to the presence of the highly oxophilic Al powder, it is clearly observed that, even being sintered under high temperature in the air, an Ni—Al alloy or a metallic Ni is formed with its high conductivity still remained.

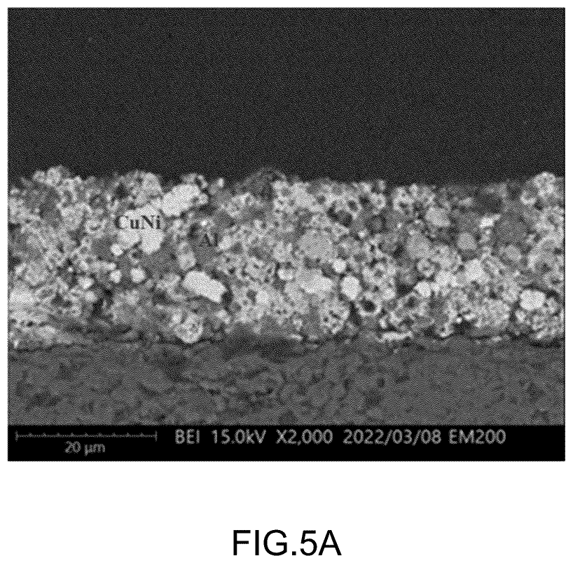

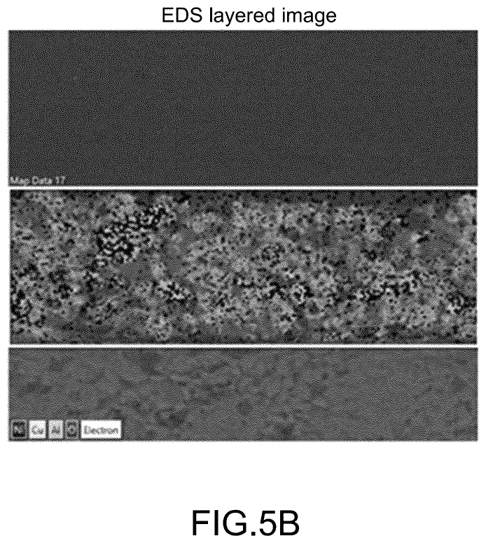

FIG. 5A˜5B shows the microstructure of a alloy Cu—Ni powder added with a metallic Al powder to be sintered at a temperature of 850° C./min in the air. Due to the presence of the highly oxophilic Al powder, it is clearly observed that, even being sintered under high temperature in the air, the Cu—Ni alloy still remains its high conductivity.

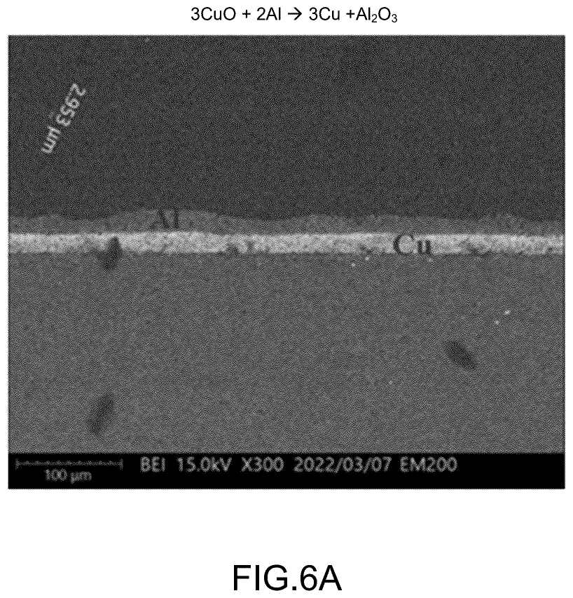

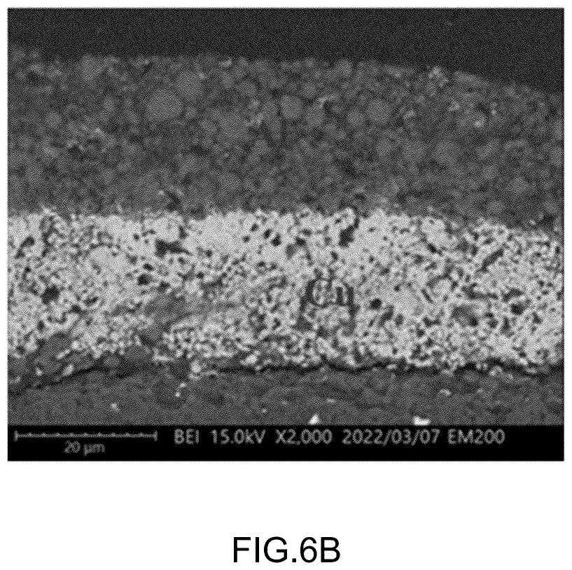

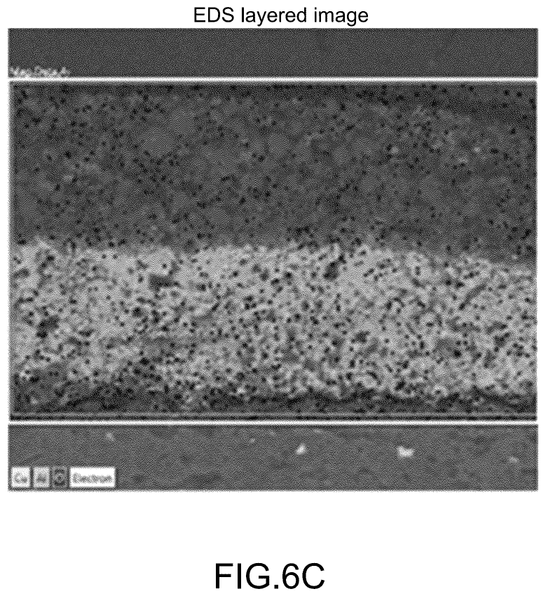

FIG. 6A˜6C shows a printed Al film coated on a printed metallic Cu film with the microstructure obtained under a sintering temperature of 850° C. in the air. Due to the presence of a metallic Al film characterized in high oxophilicity and strong reduction, it is clearly observed that, even being sintered under high temperature in the air, the metallic Cu film at lower layer still remains its high conductivity.

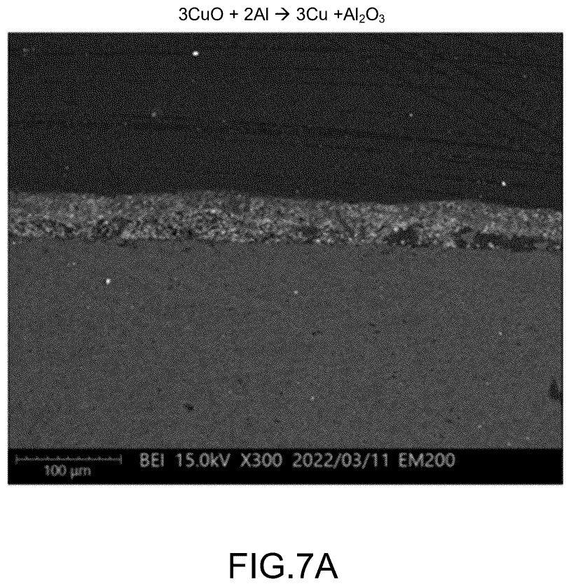

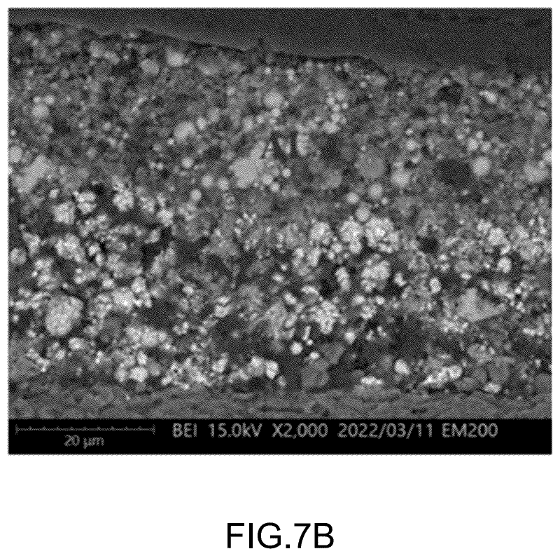

FIG. 7A˜7C shows the printed Al film coated on the printed metallic Ni film with the microstructure obtained under a sintering temperature of 850° C. in the air. Due to the presence of a metallic Al film characterized in high oxophilicity and strong reduction, it is clearly observed that, even being sintered under high temperature in the air, the metallic Ni film still remains its high conductivity.

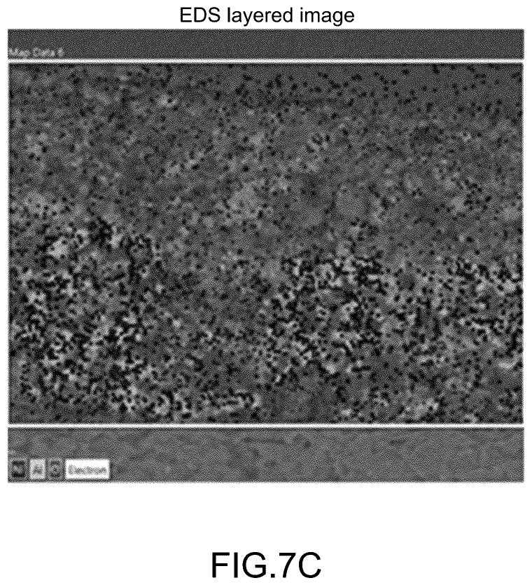

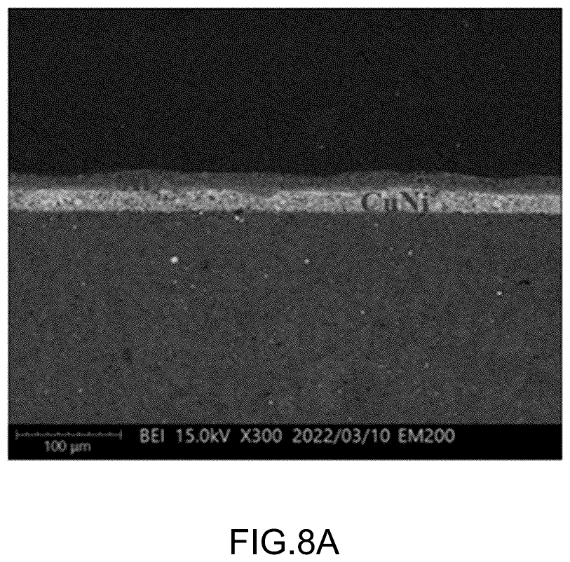

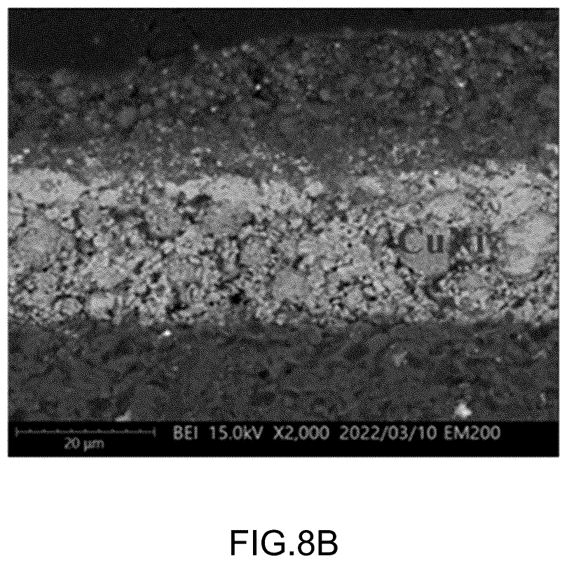

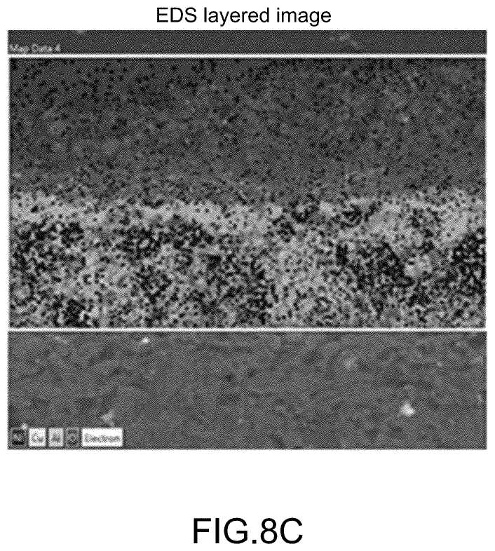

FIG. 8A˜8D shows the printed Al film coated on the printed metallic Cu—Ni film with the microstructure obtained under a sintering temperature of 850° C. in the air. Due to the presence of an metallic Al film characterized in high oxophilicity and strong reduction, it is clearly observed that, even being sintered under high temperature in the air, the alloy Cu—Ni film still remains its high resistance.

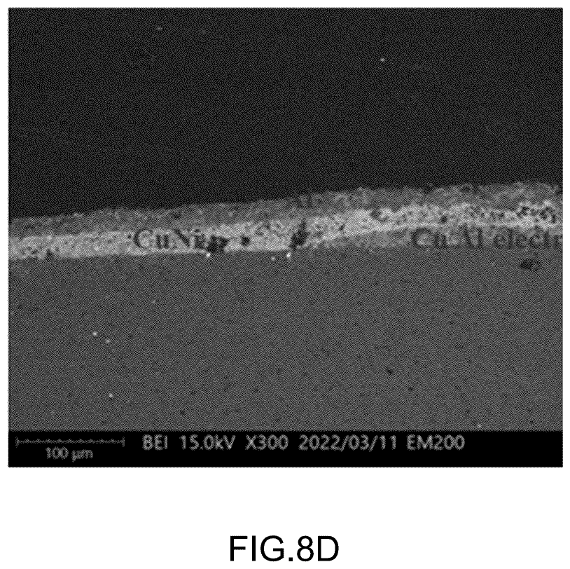

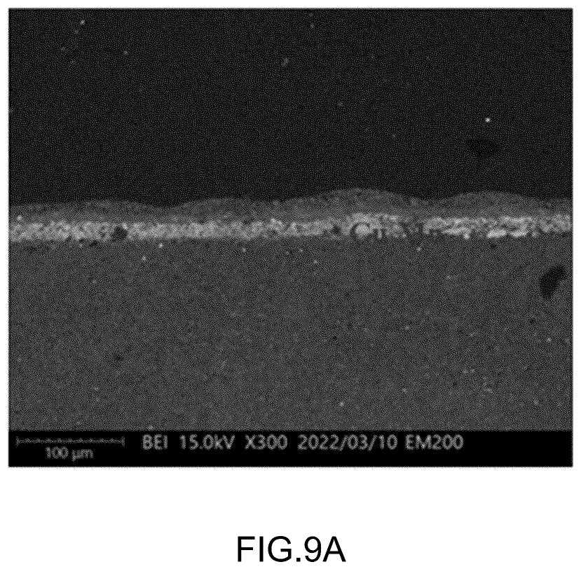

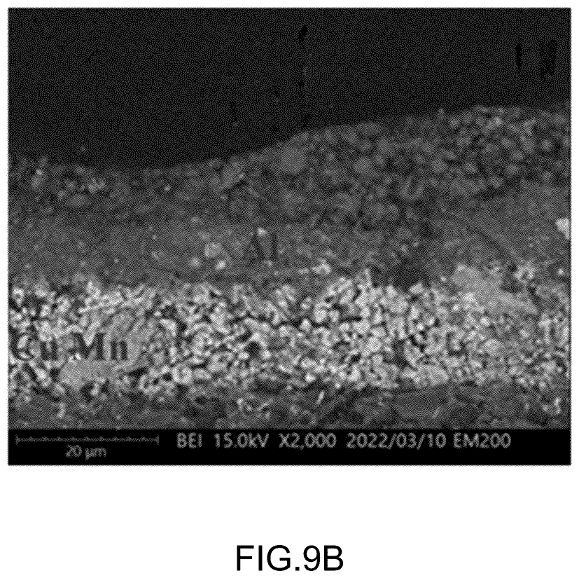

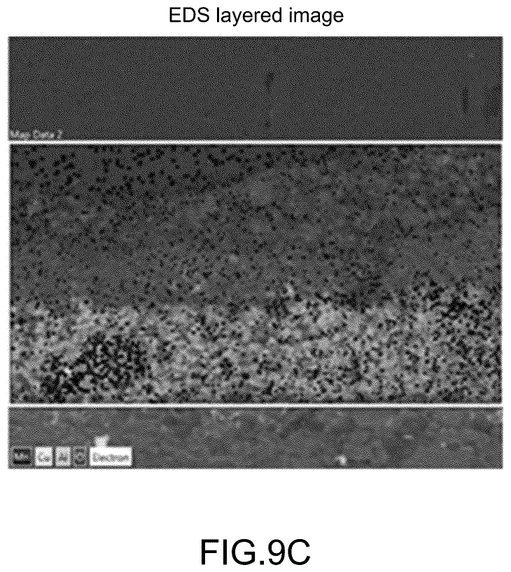

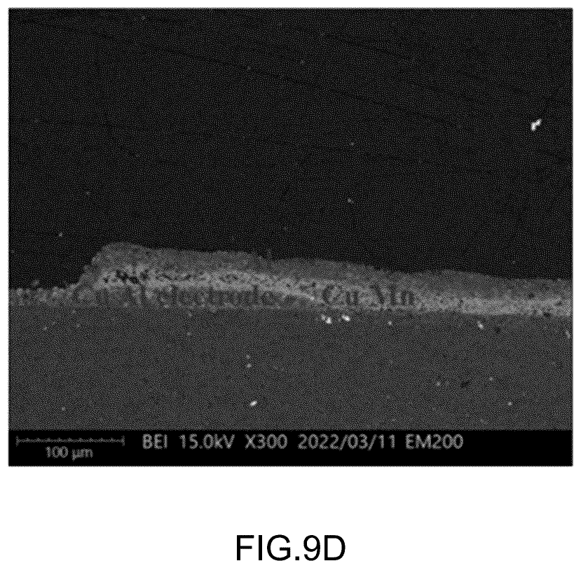

FIG. 9A˜9D shows the printed Al film coated over the printed metallic Cu—Mn film with the microstructure obtained under a sintering temperature of 850° C. in the air. Due to the presence of the Al film characterized in high oxophilicity and strong reduction, it is clearly observed that, even being sintered under high temperature in the air, the alloy Cu—Mn film still remains its high resistance.

### [State-of-Use 1]

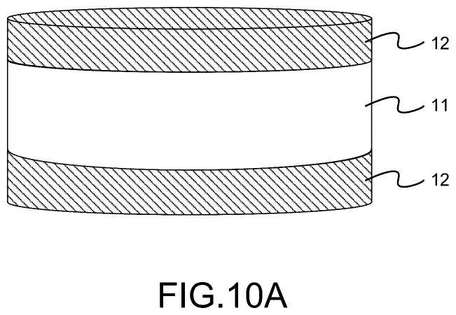

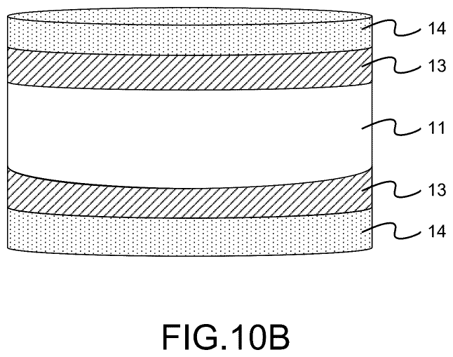

The present invention provides a novel method of fabricating an external electrode of a block-shaped ceramic part. The block-shaped ceramic part is a GPS ceramic antenna, a thermistor with negative temperature coefficient (NTC), a thermistor with positive temperature coefficient (PTC), a voltage dependent resistor (VDR), or a safety capacitor, as shown in FIG. 10A˜10C.

The present invention uses a mixture of Cu—Al (or Ni—Al) to fabricate a conductive paste to be printed on both sides of the block-shaped ceramic part 11 for forming Cu—Al (or Ni—Al) electrode 12 as external electrode to process a heat treatment at 500˜1000° C. in the air, as shown in diagram of FIG. 10A.

Nonetheless, the present invention may, at first, have Cu (or Ni) electrode 13 printed on both sides of the block-shaped ceramic part 11, separately, and an Al electrode 14 printed on the Cu (or Ni) electrode 13. Then, a heat treatment is processed at 500˜1000° C. in the air. The Al electrode 14 above protects the Cu (or Ni) electrode 13 below from oxidation, as shown in diagram of FIG. 10B.

### [State-of-Use 2]

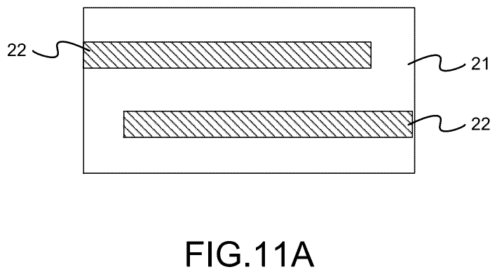

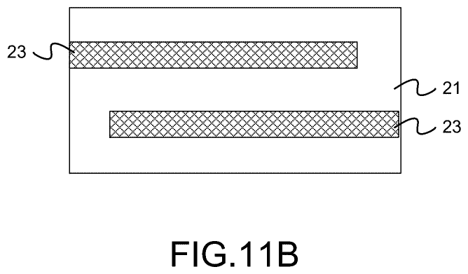

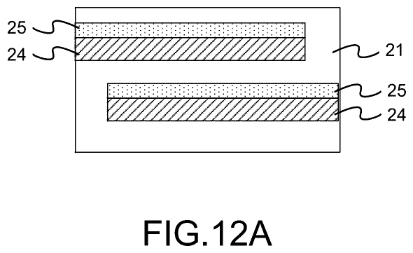

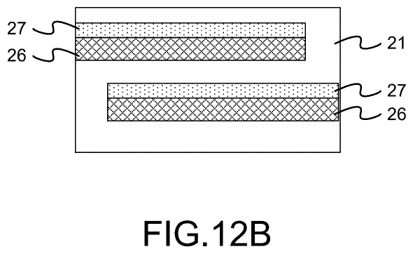

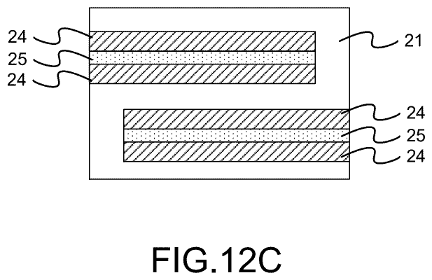

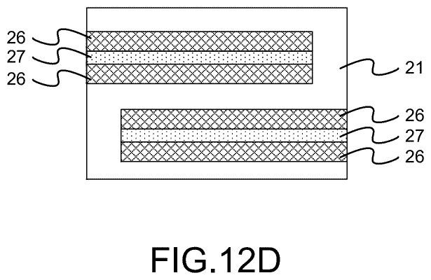

The present invention provides a novel method of fabricating a multilayer ceramic part as an inner electrode. The multilayer ceramic part is a low temperature co-fired ceramic (LTCC) part, a multilayer ceramic capacitor (MLCC), a multilayer NTC part, a Multilayer VDR part, or a multilayer piezoelectric part, as shown in FIG. 11A˜11B and FIG. 12A˜12D.

1. Regarding the multilayer ceramic co-firing part, at a sintering temperature below 1050° C., a Cu thick-film conductive paste is mixed with 10˜90 wt % of an Al powder to print Cu—Al electrode 22 as inner electrode to be co-fired with a ceramic green body 21 in the air, which is LTCC as shown in diagram of FIG. 11A. At a sintering temperature of 1050˜1450° C., a Ni (or Ni—Cu) thick-film conductive paste is mixed with 10˜90 wt % of an Al powder to print Ni—Al electrode 23 as inner electrode to be co-fired with a ceramic green body 21 in the air, which is MLCC as shown in diagram of FIG. 11B.

2. Regarding the multilayer ceramic co-firing part, at a sintering temperature below 1050° C., a layer of a Cu thick-film conductive paste is obtained at first and then is printed with a layer of a thick-film Al conductive paste film with two layers of a Cu electrode 24 and an Al electrode 25 as inner electrodes to be co-fired with a ceramic green body 21 in the air, which is LTCC as shown in diagram of FIG. 12A. At a sintering temperature of 1050˜1450° C., a layer of a Ni (or Cu—Ni) thick-film conductive paste film is obtained at first and then is printed with a layer of a thick-film Al conductive paste film with two layers of a Ni (or Cu—Ni) electrode 26 and an Al electrode 237 as inner electrodes to be co-fired with a ceramic green body 21 in the air, which is MLCC as shown in diagram of FIG. 12B.

3. Regarding the multilayer ceramic co-firing part, at a sintering temperature below 1050° C., a layer of a Cu thick-film conductive paste film is obtained at first with three layers of a Cu electrode 24, an Al electrode 25, and another Cu electrode 24 as inner electrodes to be co-fired with a ceramic green body 21 in the air, which is LTCC as shown in diagram of FIG. 12C. At a sintering temperature of 1050˜1450° C., a layer of a Ni (or Cu—Ni) thick-film conductive paste film is obtained at first and then is printed with a layer of conductive Al paste thick-film Finally, a layer of an Ni (or Cu—Ni) thick-film conductive paste film is printed with three layers of an Ni (or Cu—Ni) electrode 26, an Al electrode 27, and another Ni (or Cu—Ni) electrode 26 as inner electrodes to be co-fired with a ceramic green body 21 in the air, which is MLCC as shown in diagram of FIG. 12D.

4. Because of the Al electrode contained in the co-fired inner electrodes, it is possible to be non-shrunk on X and Y axes yet inhibit being sintered on Z axis only when co-firing with the ceramic green body. The electrode pattern which requires precise control is nearly unchanged after being printed and sintered. In addition, due to the shrinkage focused on the Z axis as the thickness direction after sintering, the multilayer ceramic capacitor multiplies its capacitance by reducing the thickness of the dielectric layer.

### [State-of-Use 3] Chip Resistor

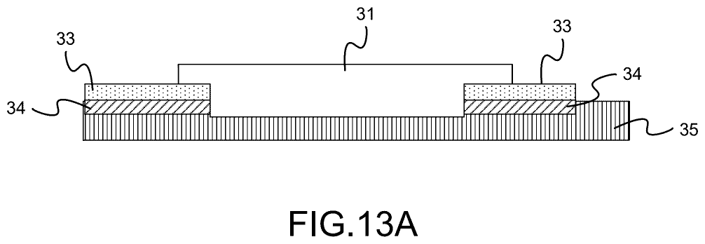

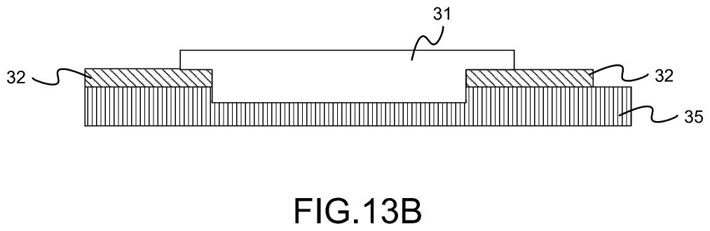

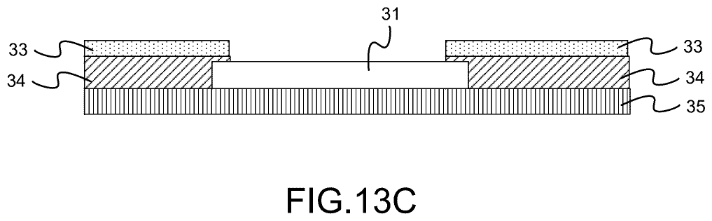

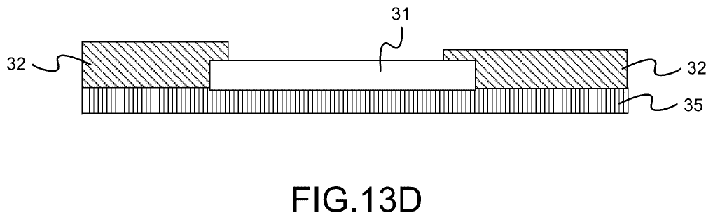

1. The present invention provides a novel method of fabricating a chip-resistor electrode. In FIG. 13A˜13D, diagram (a) and diagram (b) show the lower electrodes and diagram (c) and diagram (d) show the upper electrodes.

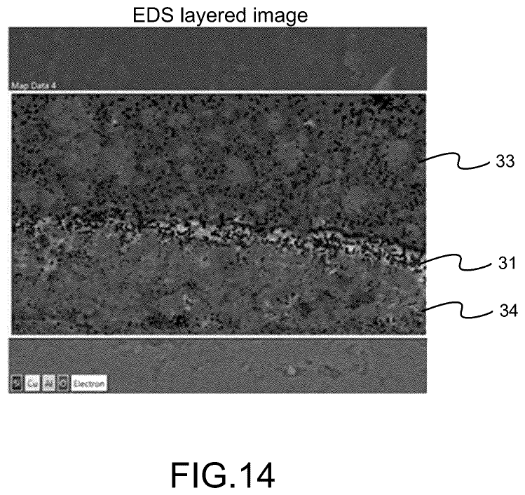

Regarding the fabrication of positive electrode connected to chip resistor and resistor layer 31, a positive-electrode conductive paste of Cu (or Cu—Ni) added with 10˜90 wt % of an Al powder is printed on a substrate 35 (such as alumina substrate) to connect to a resistor film and then a heat treatment is processed at 500˜1400° C. Or, a layer of a Cu (or Cu—Al) conductive paste film is printed to connect to a resistor film; then, a layer of an Al conductive paste film is printed to protect the Cu (or Cu—Al) paste film; and, then, a heat treatment is processed at 500˜1400° C. Thus, a high-conductivity Al—Cu electrode 32 is fabricated through being sintered in the air (as shown in diagram of FIG. 13B and FIG. 13D). Or, a Cu (or Cu—Al) electrode 34 covered with an Al electrode 33 (as shown in diagram of FIG. 13A and FIG. 13C) is connected with the resistor layer 31, or the resistor layer 31 is printed on the Cu—Al electrode 34 with the Al electrode 33 printed as a protection layer. A result obtained after a high-temperature sintering is shown in FIG. 14, where the stability of the feature of the resistor are as good as that of a modern high-conductivity positive silver (Ag) electrode sintered in the air.

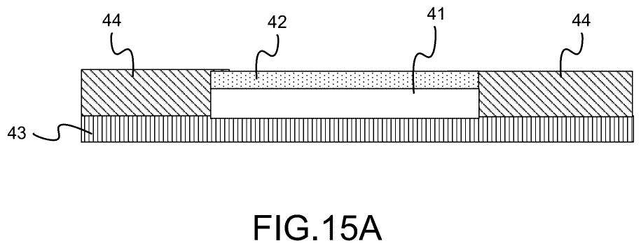

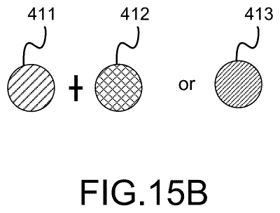

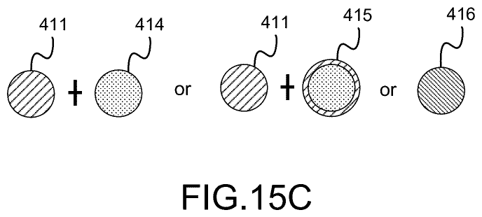

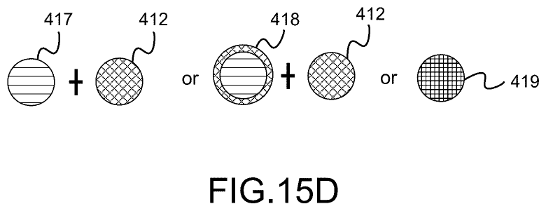

2. The present invention provides a novel method of fabricating an alloy chip resistor as shown in FIG. 15A˜15D.

### Method 1: Alloy Powder+Al Powder

A powder of an alloy, such as Cu—Ni alloy, cu-Mn alloy, or Ni—Cr alloy, is added with
an appropriate amount of an Al powder to be mixed to form a resistor paste to be printed to form a resistor film to be sintered at 500˜1400° C., where the oxidation of the alloy powder is prevented by the addition of the Al powder to maintain the high-performance resistance of the alloy film.
   Method 2: Cu, Ni, Mn, and Cr Mixed Film Coated with Al Film

At first, an alloy resistor paste is printed on the surface of an (alumina) substrate 43 having Al—Cu electrode 44, to obtain an alloy film, like a Cu—Ni film, a Cu—Mn film, or an Ni—Cr (silicon (Si)) film. Then, another layer of a thick-film Al film is printed on the alloy film. A Cu—Ni (or Cu—Mn, Ni—Cr) alloy resistor layer 41 coated with an Al (or Al—Ni) layer 42 is formed through a heat treatment at 500˜1400° C. The alloy film is prevented from oxidation during the heat treatment by the printed Al conductive paste film to maintain the high-performance resistance of the alloy film, as shown in diagram of FIG. 15A.

Therein, the Cu—Ni film is fabricated by mixing a metallic Cu powder 411 and a metallic Ni powder 412 to obtain required characteristics through a specific ratio, or made with a Cu—Ni alloy powder 413, as shown in diagram of FIG. 15B.

Therein, the Cu—Ni film is fabricated by mixing a metallic Cu powder 411 together with a metallic Ni powder 414 or a Cu-coated Mn powder 415 to obtain required characteristics through a specific ratio, or made with a Cu—Mn alloy powder 416, as shown in diagram of FIG. 15C.

Therein, the Ni—Cr film is fabricated by mixing a metallic Ni powder 412 together with a metallic Cr powder 417 or a Ni-coated Cr powder 418 to obtain required characteristics through a specific ratio, or made with an Ni—Cr alloy powder 419, as shown in diagram of FIG. 15D.

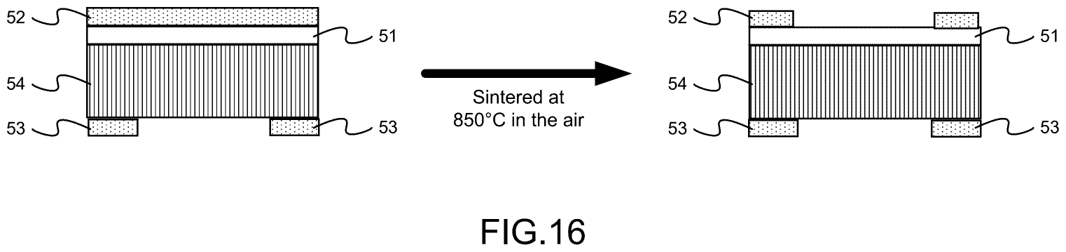

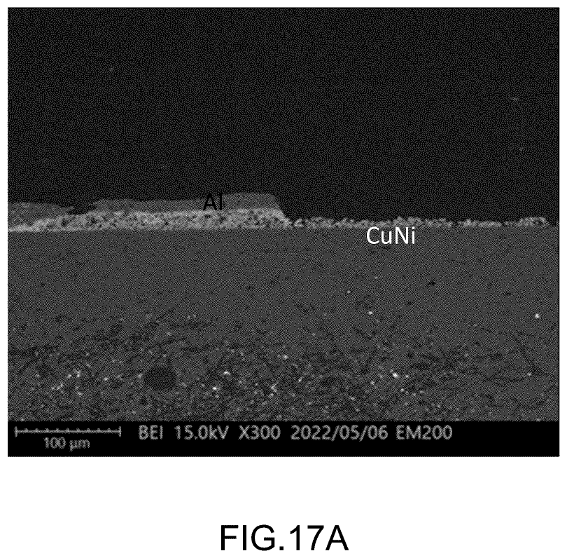

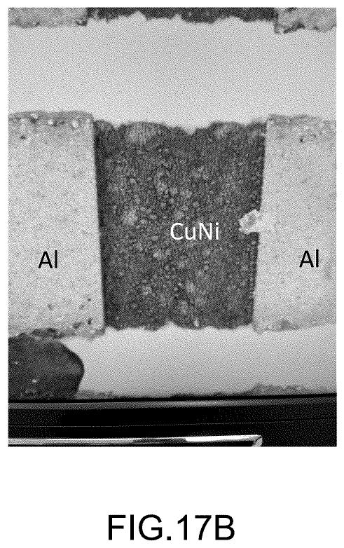

Nonetheless, the present invention provides a novel method of fabricating a base-metal alloy chip resistor. As shown in FIG. 16, a base-metal alloy resistor paste is printed on a substrate 51 at first to obtain an alloy film, like a Cu—Ni film, a Cu—Mn film, or an Ni—Cr (silicon (Si)) film. Then, an anti-oxidation Al film is printed for protection. After an Al layer 52,53 together with a Cu—Ni (or Cu—Mn, Ni—Cr) alloy resistor layer 54 covered with the Al layer 52 are formed through sintering at a high temperatures (e.g. 850° C.) in the air, the Al layer located at middle on the Cu—Ni (or Cu—Mn, Ni—Cr) alloy resistor layer 54 is then removed through laser engraving, whose structure is shown as electronic images in diagram of FIG. 17A and FIG. 17B. Thus, two ends are formed without being removed by the laser engraving, where the Al layer 52 at the both ends are left as end electrodes for the alloy chip resistor.

Hence, the following technical features are required for implementing the present invention:
1. 10˜90 wt % of a metallic Al powder added to a thick-film printing base-metal (e.g. Ni, Cu) powder or base-metal alloy (e.g. Cu—Ni, Cu—Mn, Ni—Cr) powder for processing a heat treatment at 500˜1400° C. in the air prevents the base metal or alloy from oxidation. Thus, a thick-film base-metal electrode film or alloy film is obtained with high performance feature.
2. A layer of a base-metal (e.g. Ni, Cu) conductive paste film or base-metal alloy (e.g. Cu—Ni, Cu—Mn, Ni—Cr (Si)) paste film is printed through thick-film printing. Then, a layer of a thick-film printed Al conductive paste film is printed on the base-metal conductive paste film or base-metal alloy paste film to process a heat treatment at 500˜1400° C. in the air. The base metal or alloy is prevented from oxidation by the Al layer for obtaining the thick-film printed base-metal electrode film or alloy film with high performance feature. Then, the Al layer at middle for protection is removed through laser engraving. Thus, two ends are formed without being removed by the laser engraving, where the Al layer left at both ends are used as end electrodes for the alloy chip resistor.
3. Regarding the multilayer ceramic co-firing part, at a sintering temperature below 1050° C., a Cu thick-film conductive paste is mixed with 10˜90 wt % of an Al powder to be printed as inner electrode to be co-fired with a ceramic green body in the air, such as LTCC; or, at a sintering temperature of 1050˜1450° C., an Ni or Ni—Cu thick-film conductive paste is mixed with 10˜90 wt % of an Al powder to be printed as inner electrode to be co-fired with a ceramic green body in the air, such as MLCC.
4. Regarding the multilayer ceramic co-firing part, at a sintering temperature below 1050° C., a layer of conductive Cu thick-film conductive paste film is obtained at first and then is printed with a layer of a thick-film Al conductive paste film coated on top. With the concept of multilayer electrode, the two layers are used as inner electrode to be co-fired with a ceramic green body in the air, such as LTCC; or, at a sintering temperature of 1050˜1450° C., a layer of an Ni or Ni—Cu thick-film conductive paste film is obtained at first and then is printed with a layer of an thick-film Al conductive paste film. With the concept of multilayer electrode, the two layers are used as inner electrode to be co-fired with the ceramic green body in the air, such as MLCC.
5. Regarding the multilayer ceramic co-firing part, at a sintering temperature below 1050° C., a layer of a Cu thick-film conductive paste film is obtained at first, a layer of a thick-film Al conductive paste film is printed then, a layer of a Cu thick-film conductive paste film is printed at last, and, with the concept of multilayer electrode, the three layers are used as inner electrode to be co-fired with a ceramic green body in the air, such as LTCC; or, at a sintering temperature of 1050˜1450° C., a layer of an Ni (or Cu—Ni) thick-film conductive paste film is obtained at first, a layer of a thick-film Al conductive paste film is printed then, a layer of an Ni or Ni—Cu thick-film conductive paste film is printed at last, and, with the concept of multilayer electrode, the three layers are functioned as inner electrode to be co-fired with the ceramic green body in the air, such as MLCC.
6. Regarding the fabrication of positive electrode connected with chip resistor and resistor layer, a positive-electrode conductive paste made of Cu (or Cu—Al) added with 10˜90 wt % of an Al powder is printed at first to connect to a resistor film, and, then, a heat treatment is processed at 500˜1400° C.; or, a layer of a Cu (or Cu—Al) conductive film is printed to connect to a resistor film, an Al conductive paste film is printed to protect the Cu (or Cu—Al) conductive film from oxidation at high temperature, and, then, a heat treatment is processed at 500˜1000° C.
7. For a semiconductor ceramic PTC thermistor electrode, not only a high conductivity is required, but also an ohmic contact has to be obtained with a semiconducting ceramic, where the ohmic contact is formed by adjusting the ratio of Al (10˜90 wt %) added to Cu and Ni for achieving different functions of thick-film electrode.
8. An alloy resistor-paste is printed at first to obtain an alloy film, like Cu—Ni film, Cu—Mn film, or Ni—Cr (silicon (Si)) film. Then another layer of a thick-film Al film is printed on the alloy film to protect the alloy film from oxidation during a heat treatment (500˜1400° C.) for remaining the high-performance resistance of the alloy film.

The key technical features of the present invention are different from prior arts in the following:
1. In contrast, all existing technologies must process the heat treatment to a base-metal thick-film printed conductive Cu, Ni, Cu—Ni alloy paste under a restoring atmosphere, e.g. heat treatment of sintering under a nitrogen gas or a nitrogen-hydrogen mixed gas, to prevent the base metal of Cu, Ni, or other alloy from being oxidized and further losing functions.
The present invention is novel in adding or coating an Al powder or Al film with high oxidation and strong reduction to protect the base metal of Cu, Ni, or other alloy, where oxidation is prevented with no loss in functions even when a heat treatment of sintering is processed at high temperature in the air.
2. In contrast, a modern multilayer ceramic part has a mismatch problem owing to the shrinkage happened on co-firing ceramic green body with electrode. Existing technical solutions includes covering a non-shrinkable ceramic green body, which stands for a higher temperature for co-firing than the original ceramic green body; or inserting another ceramic green body that stands for a lower temperature for co-firing than the original ceramic green body to achieve a shrinkage suppression technology that there is no shrinkage on X and Y axes on co-firing. Thus, the mismatch of the ceramic green body to electrode is reduced.
However, the present invention uses the non-shrinkage feature of the metallic electrode co-fired with the ceramic green body to achieve the shrinkage suppression technology that there is no shrinkage on X and Y axes on co-firing, so that the mismatch of the ceramic green body to electrode is reduced.
3. In contrast, for the modern way of fabricating external electrode with ceramic part, the sintered ceramic body changes its features after being sintered in a restoring atmosphere for obtaining the external electrode, like chip resistor, NTC, PTC, VDR, and Piezoelectric PZT. Therefore, a nitrogen-sintered Cu electrode is not applicable.
However, the present invention uses a thick-film Al film to protect a thick-film Cu electrode film on processing a heat treatment in the air. Thus, a ceramic part, like chip resistor, NTC, PTC, VDR, and piezoelectric PZT, is used to fabricate a Cu electrode.
4. In contrast, a modern alloy resistor has a very low resistance temperature coefficient. Its manufacturing method is mainly to use an alloy of precious metals like Ag-palladium (Pd) to be sintered in the air; or to sinter an alloy of base metals like Cu—Ni in a restoring nitrogen (or nitrogen-hydrogen) atmosphere.

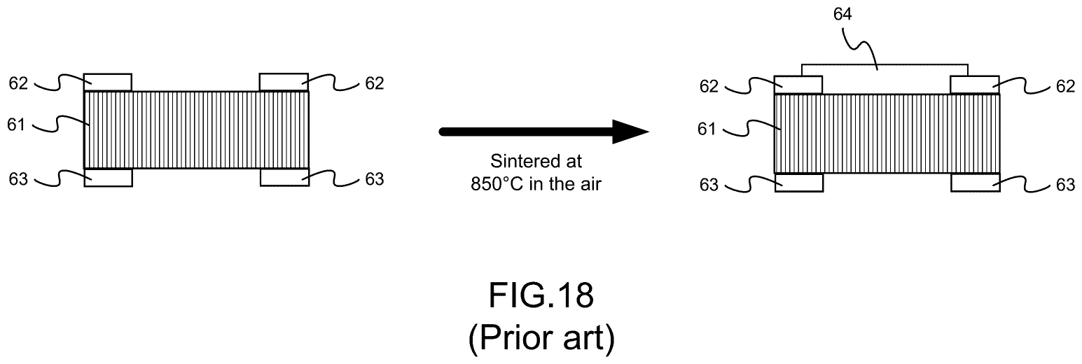

However, the present invention fabricates a base-metal alloy (e.g. Cu—Ni, Cu—Mn, Ni—Cr) resistor to be sintered in an air atmosphere to obtain features equivalent to those of which (e.g. Cu—Ni, Cu—Mn, Ni—Cr) are sintered in a restoring atmosphere. Moreover, the proposed novel method of fabricating an air-sintered chip-type base-metal alloy resistor is different from the modern method of fabricating the chip alloy resistor, where the modern method traditionally prints a positive electrode paste on both ends at first, an alloy resistance-paste is then printed, and precious-metal Ag electrodes 62, 63, and an Ag—Pd alloy resistor layer 64 are then sintered in the air for fabrication, as shown in FIG. 18; or a base-metal Cu electrode or Cu—Ni alloy resistor layer is sintered in a restoring nitrogen atmosphere for fabrication.

However, the present invention prints a base-metal alloy resistor paste; an anti-oxidation Al film is then printed for protection to be sintered together at high temperature in the air; then, the Al layer at middle as a protection is removed through laser engraving; and, then, two ends which are not removed through the laser engraving are formed as two terminal electrodes of chip resistor.

Thus, the present invention is a method for obtaining base metal and alloy through high-temperature sintering and anti-oxidizing in the air, where the materials for thick-film-printed electrode are completely changed from precious metals to base metals. Moreover, unlike the current practices where a reduction atmosphere is required for sintering at high temperatures to avoid metal oxidization if precious metals are replaced by base metals, the present invention is the first to allow very cheap base metals or alloys to be sintered at high temperature in the very cheap air with oxidation prevented while maintaining excellent electrical features. Therefore, relevant industries do not need to change sintering equipment and original equipment can still use for sintering in the air. In other words, it is possible to use base metals instead of precious metals to significantly reduce material cost without purchasing new equipment. It will lead related technologies for thick-film printed electrode or alloy in a revolutionary way.

To sum up, the present invention is a method for obtaining base metal and alloy through high-temperature sintering and anti-oxidizing in the air, where the materials for thick-film-printed electrode are completely changed from precious metals to base metals; the present invention is the first to allow very cheap base metals or alloys to be sintered at high temperature in the very cheap air with oxidation prevented while maintaining excellent electrical features; and the material cost is significantly reduced with no additional equipment required.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for obtaining base metal and alloy through high-temperature sintering and anti-oxidizing in the air, wherein 10˜90 weight percent (wt %) of a metallic aluminum (Al) powder is added to a thick-film printed paste, selected from a group consisting of a thick-film printed base-metal conductive paste and a thick-film printed base-metal alloy paste to process a heat treatment at 500˜1400 degrees Celsius (° C.) in the air with the high oxophilicity of said metallic Al powder protecting said thick-film printed paste from oxidation on being sintered at high temperature in the air; at a chance of causing said thick-film printed paste oxidized on being sintered at high temperature in the air, said oxidized thick-film printed paste is reduced back to a material selected from a group consisting of a metal and an alloy through the strong reduction of said metallic Al powder; and a film selected from a group consisting of a thick-film base-metal electrode film and a thick-film base-metal alloy film is thus obtained.

2. The method according to claim 1,
wherein said conductive base-metal paste is of a powder selected from a group consisting of a metallic copper (Cu) powder and a metallic nickel (Ni) powder; said base-metal alloy paste is of an alloy powder selected from a group consisting of a Cu—Ni alloy powder, a Cu-manganese (Mn) alloy powder, and an Ni-chromium (Cr) alloy powder.

3. The method according to claim 1,
wherein said thick film is applied to a block ceramic external-electrode part, a multilayer ceramic inner-electrode part, a chip-resistor electrode, and an alloy chip resistor.

4. The method according to claim 3,
wherein said block ceramic external-electrode part is a GPS ceramic antenna, a thermistor with negative temperature coefficient (NTC), a thermistor with positive temperature coefficient (PTC), a voltage dependent resistor (VDR), and a safety capacitor.

5. The method according to claim 3,
wherein the multilayer ceramic part is a low temperature co-fired ceramic (LTCC) part, a multilayer ceramic capacitor (MLCC), a multilayer NTC part, a Multilayer VDR part, and a multilayer piezoelectric part.

6. A method for obtaining base metal and alloy through high-temperature sintering and anti-oxidizing in the air,
wherein a layer of a thick-film Al conductive paste film is printed on a paste film, selected from a group consisting of a thick-film printed base-metal conductive paste film and a thick-film printed base-metal alloy paste film, to process a heat treatment at 500˜1400° C. in the air with the high oxophilicity of said conductive Al paste thick-film protecting said paste film from oxidation on being sintered at high temperature in the air; at a chance of causing said paste film oxidized on being sintered at high temperature in the air, said oxidized paste film is reduced back to a material selected from a group consisting of a metal and an alloy through the strong reduction of said conductive Al paste thick-film; and a film selected from a group consisting of a thick-film base-metal electrode film and a thick-film base-metal alloy film is thus obtained.

7. The method according to claim 6,
wherein said conductive base-metal paste film is selected from a group consisting of a metallic copper (Cu) film and a metallic nickel (Ni) film; and said base-metal alloy paste-film is selected from a group consisting of a Cu—Ni alloy paste-film, a Cu—Mn alloy paste-film, and an Ni—Cr alloy paste-film.

8. The method according to claim 6,
wherein said thick film is applied to a block-shaped ceramic part of external electrode, a multilayer ceramic part of inner electrode, a chip-resistor electrode, and an alloy chip resistor.

9. The method according to claim 8,
wherein said block-shaped ceramic part is selected from a group consisting of a GPS ceramic antenna, an NTC thermistor, a PTC thermistor, a VDR, and a safety capacitor; and said multilayer ceramic part is selected from a group consisting of an LTCC part, an MLCC part, a multilayer NTC part, a multilayer VDR part, and a multilayer piezoelectric part.

10. The method according to claim 6,
wherein said thick film is applied to fabricate an alloy chip resistor; wherein a middle part of said layer of Al being a protection is removed through lightning to expose said alloy resistor layer; and both ends of said layer of Al are not removed by lightning and are end electrodes of said alloy chip resistor.
